(19) United States
(12) Patent Application Publication
(10) Pub. No.: US 2024/0119376 A1
(43) Pub. Date: Apr. 11, 2024

(54) METHOD AND APPARATUS FOR MANAGING REMOTE SERVICE

(71) Applicant: TOYOTA JIDOSHA KABUSHIKI KAISHA, Toyota-shi Aichi-ken (JP)

(72) Inventor: Hiromitsu Urano, Numazu-shi Shizuoka-ken (JP)

(73) Assignee: TOYOTA JIDOSHA KABUSHIKI KAISHA, Toyota-shi Aichi-ken (JP)

(21) Appl. No.: 18/467,240

(22) Filed: Sep. 14, 2023

(30) Foreign Application Priority Data
Oct. 7, 2022 (JP) 2022-162379

(51) Int. Cl. G06Q 10/0631; G06Q 50/30

(52) U.S. Cl. CPC G06Q 10/063116; G06Q 50/30

(57) ABSTRACT

A method for managing a remote service for mobile objects is provided. The method includes the step of assigning, when a start trigger of a service business to an object for which the remote service is provided is output, the service business to at least one operator among a plurality of operators engaged in the remote service. The service business includes a first business which affects travel efficiency of the object of the remote service and a second business which does not affect the travel efficiency. In the step of assigning the service business, in the event that a start trigger of the first business for the object of the remote service is output, when there is an operator already engaged in the second business for the object of the remote service, the first business is assigned to the operator.

### CROSS-REFERENCE TO RELATED APPLICATION

The present disclosure claims priority under 35 U.S.C. § 119 to Japanese Patent Application No. 2022-162379, filed on Oct. 7, 2022, the content of which application is incorporated herein by reference in their entirety.

### FIELD

The present disclosure relates to a method and an apparatus for managing a remote service for mobile objects.

### BACKGROUND

JP 2018-142265 A discloses a method for managing a remote service of self-driving vehicles. In this conventional method, when it is determined that a given self-driving vehicle needs to be remotely operated, an operator on standby is selected from a plurality of operators and remote operation is assigned to the selected operator. Therefore, according to the convention method, a remote service of a plurality of self-driving vehicles can be efficiently run by a small number of operators.

JP 2021-144732 A is an example of a document describing a level of technology of a technical field related to the present disclosure besides JP 2018-142265 A.

### SUMMARY

An operator who performs a remote operation of a mobile object such as a self-driving vehicle acquires information related to the mobile object in the remote operation to comprehend surroundings of the mobile object and contents of a task of remote operation that is required of the operator. Information related to the mobile object includes sensor information represented by a camera image acquired by a camera mounted to the mobile object. The sensor information is typically visualized and output to a display. Output of the sensor information to the display is expected to facilitate early comprehension of the surroundings of the mobile object and the like.

However, it is inevitable that the time required by an operator having been on standby for a remote operation to comprehend the surroundings and the like is longer than the time required to comprehend the surroundings and the like by a driver sitting on a driver's seat of the mobile object. This is because, while the driver is expected to constantly comprehend surroundings of a mobile object being driven by the driver, it is unrealistic to expect an operator having been on standby for a remote operation to have a same degree of comprehension of the surroundings as the comprehension by the driver.

Requiring an operator having been on standby for a remote operation to have a same degree of comprehension of the surroundings as the comprehension by the driver leads to a reduction in a business processing amount per unit time by the operator and rising labor costs and is, therefore, undesirable. In addition, when selecting one operator from a plurality of operators and assigning a remote operation to the selected operator, there is also an aspect that it is substantially impossible for each operator to comprehend information related to a mobile object that needs to be remotely operated even before a determination is made that a remote operation is necessary.

An object of the present disclosure is to provide a technique that enables a remote service of mobile objects including remote operations to be run smoothly when the remote service is to be provided by a plurality of operators.

A first aspect of the present disclosure is a method for managing a remote service for mobile objects and has the following features.

The method comprises the step of assigning, when a start trigger of a service business to an object for which the remote service is provided is output, the service business to at least one operator among a plurality of operators engaged in the remote service. The service business includes a first business which affects travel efficiency of the object of the remote service and a second business which does not affect the travel efficiency.

The step of assigning the service business includes the steps of:
determining, when a start trigger of the first business for the object of the remote service is output, whether or not an operator already engaged in the second business for the object of the remote service is included in the plurality of operators; and
appointing, when it is determined that an operator already engaged in the second business for the object of the remote service is included in the plurality of operators, the operator having been already engaged in the second business for the object of the remote service to be an operator in charge of the first business for the object of the remote service.

A second aspect of the present disclosure is an apparatus for managing a remote service for mobile objects and has the following features.

The apparatus comprises a processor configured to manage the remote service.

The processor is configured to execute processing to assign, when a start trigger of a service business to an object for which the remote service is provided is output, the service business to at least one operator among a plurality of operators engaged in the remote service. The service business includes a first business which affects travel efficiency of the object of the remote service and a second business which does not affect the travel efficiency.

In the processing to assign the service business, the processor is configured to execute:
processing to determine, when a start trigger of the first business for the object of the remote service is output, whether or not an operator already engaged in the second business for the object of the remote service is included in the plurality of operators; and
processing to appoint, when it is determined that an operator already engaged in the second business for the object of the remote service is included in the plurality of operators, the operator having been already engaged in the second business for the object of the remote service to be an operator in charge of the first business for the object of the remote service.

According to the present disclosure, in the event that a start trigger of a first business for an object of a remote service is output, when there is an operator already engaged in a second business for the object of the remote service, the first business is assigned to the operator. Therefore, the time required by the operator to comprehend surroundings of the object of the remote service and the like can be reduced. As a result, a contribution is expected to be made towards smoothly running a remote service when the remote service is to be provided by a plurality of operators.

### BRIEF DESCRIPTION OF DRAWINGS

FIG. 1 is a conceptual diagram illustrating a remote service;

FIG. 2 is a diagram showing an example of an image that is output from a display of a terminal operated by an operator;

FIG. 3 a diagram showing another example of the image that is output from the display of the terminal operated by the operator;

FIG. 4 is a diagram showing an example of the image that is output from the display when a first task for a vehicle is assigned, corresponding to two different states of the operator before this assignment;

FIG. 5 is a block diagram showing a functional configuration example of a processor of a management server particularly related to a first embodiment;

FIG. 6 is a flow chart showing a flow of processing particularly related to the first embodiment by the management server;

FIG. 7 is a diagram showing yet another example of the image that is output from the display of the terminal operated by the operator;

FIG. 8 is a block diagram showing a functional configuration example of a processor of a management server particularly related to a second embodiment;

FIG. 9 is a flow chart showing a flow of processing particularly related to the second embodiment by the management server;

FIG. 10 is a block diagram showing a functional configuration example of a processor of a management server particularly related to a third embodiment;

FIG. 11 is a flow chart showing a flow of processing particularly related to the third embodiment by the management server;

FIG. 12 is a block diagram showing a functional configuration example of a processor of a management server particularly related to a fourth embodiment;

FIG. 13 is a flow chart showing a flow of processing particularly related to the fourth embodiment by the management server; and

FIG. 14 is a block diagram showing a functional configuration example of a processor of a management server particularly related to a fifth embodiment.

### DESCRIPTION OF EMBODIMENTS

Hereinafter, a method and an apparatus for managing a remote service according to embodiments of the present disclosure will be described with reference to the drawings. The management method according to the embodiments is realized by computer processing carried out by the management apparatuses according to the embodiments. In addition, same or corresponding portions in each drawing will be denoted by same reference signs and descriptions thereof will be simplified or omitted.

### 1. First Embodiment

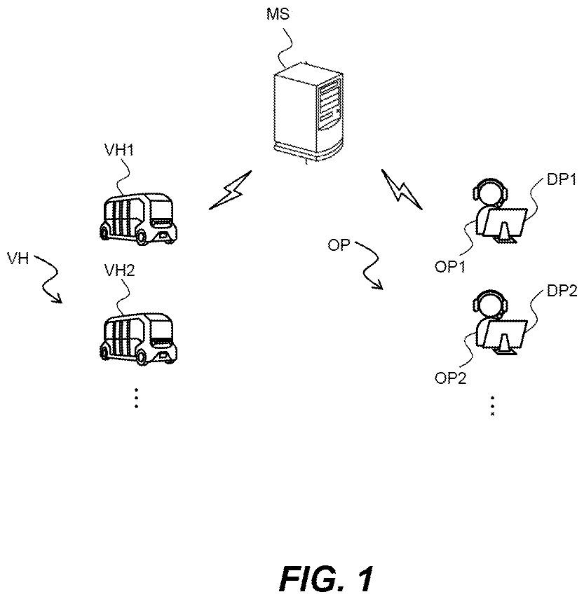

First, a first embodiment of the present disclosure will be described with reference to FIGS. 1 to 6.

### 1-1. Overview

### 1-1-1. Remote Service

FIG. 1 is a conceptual diagram illustrating a remote service. FIG. 1 shows a management server MS, a plurality of vehicles VH, and a plurality of operators OP.

The management server MS is an example of the management apparatus according to the first embodiment. The management server MS manages the remote service. Typically, the management server MS is managed by a business operator of the remote service. The management server MS communicates with the plurality of vehicles VH and the plurality of operators OP.

Each of the plurality of vehicles VH is an example of the mobile object according to the first embodiment. Each of the plurality of vehicles VH is an object for which the remote service is provided. A part of or all of the plurality of vehicles VH may be vehicles owned by the business operator of the remote service or vehicles owned by a corporation or an individual having entered into an agreement with the business operator to be provided with the remote service. The total number of the plurality of vehicles VH is M (M≥2). Hereinafter, for convenience of description, any one vehicle among the plurality of vehicles VH will be referred to as a “vehicle VHm”. While a configuration of the vehicle VHm is not particularly limited, the vehicle VHm is desirably configured to be capable of autonomous travel.

Each of the plurality of operators OP performs a service business (SB) to the object for which the remote service is provided. The plurality of operators OP may be employees of the business operator providing the remote service or employees of a corporation or individuals having entered into an outsourcing agreement with the business operator. The total number of the plurality of operators OP is N (N 2). Hereinafter, for convenience of description, any one operator among the plurality of operators OP will be referred to as an “operator OPn”.

### 1-1-2. Service Business

The service business SB performed by the operator OPn includes a first business SB1 and a second business SB2. These businesses can be distinguished from one another based on, for example, whether or not an execution of the business affects travel efficiency of the vehicle VHm. For example, the first business SB1 is a service business SB which affects travel efficiency and the second business SB2 is a service business SB which does not affect travel efficiency. “Travel efficiency” as used herein refers to, for example, a proportion of an outcome with respect to an amount of execution of the service business SB performed by the operator OPn and an example of the outcome is a time point at which the vehicle VHm arrives at a destination point.

An example of the first business SB1 is an operation business. Operation businesses include a driving business, a command business, and an assistance business. The driving business is a business involving operating apparatuses (for example, a steering wheel, a pedal, a gear shift, and turn signals of the vehicle VHm) directly or indirectly related to travel of the vehicle VHm while monitoring a peripheral image of the vehicle VHm acquired from a camera (hereinafter, also referred to as a “car-mounted camera”) mounted to the vehicle VHm.

The command business is not a business for the purpose of operating apparatuses related to travel of the vehicle VHm. However, in the command business, information related to the travel of the vehicle VHm is generated and the vehicle VHm is provided with the information. For example, let us consider a case where road debris is present ahead of the vehicle VHm and the operator OPn is requested to determine what kind of travel the vehicle VHm should perform. In this case, a business in which the operator OPn having recognized the road debris generates command information such as “follow the road” or “steer around the obstacle” is included in the command business. In addition, let us consider a case where it is difficult for the vehicle VHm to recognize a traffic light due to backlight or the like and the operator OPn is requested to perform the recognition. In this case, a business in which the operator OPn having recognized the traffic light generates recognition information that reads “the traffic light is green” is also included in the command business.

In a similar manner to the command business, in the assistance business, the vehicle VHm is provided with information related to the travel of the vehicle VHm. Unlike the command business, in the assistance business, information that takes driving experience and driving knowledge of the operator OPn (human) into consideration is generated and the vehicle VHm is provided with the information. For example, let us consider a case where the vehicle VHm about to turn right at an intersection without a traffic light encounters an oncoming vehicle about to turn right at the same intersection, and the operator OPn is requested to determine at what timing the right turn should be made. In this case, a business in which the operator OPn having recognized the driver of the oncoming vehicle or a gesture performed by the driver generates assistance information that reads “give precedence to the right turn of the oncoming vehicle since the oncoming vehicle is about to start” or “turn right first since the driver of the oncoming vehicle is yielding precedence” is included in the assistance business.

An example of the second business SB2 is a monitoring business. The monitoring business includes a business of monitoring a peripheral image of the vehicle VHm acquired from a car-mounted camera and verifying travel safety of the vehicle VHm. The car-mounted camera may include a camera for acquiring an interior image of the vehicle VHm. The monitoring business in this case includes a business of monitoring an interior image of the vehicle VHm acquired from the car-mounted camera and verifying a state of an occupant (for example, the driver) of the vehicle VHm. While various images acquired from the car-mounted camera are typically moving images, still images may be acquired instead.

The monitoring business may include a business of monitoring a visualized image of a surrounding object acquired from a recognition sensor (for example, LiDAR mounted to the vehicle VHm) other than the car-mounted camera. The monitoring business may include a business of monitoring an image of a traffic flow acquired from a camera attached to a road structure (for example, a traffic light installed at an intersection) or a visualized image of the traffic flow acquired from a recognition sensor (for example, an infrared sensor) other than a camera and indirectly verifying travel safety of the vehicle VHm. Hereinafter, a camera and a recognition sensor mounted to a road structure will be collectively referred to as an “infrastructure sensor”.

The monitoring business may include a business of monitoring travel information of the vehicle VHm acquired from a state sensor (for example, an acceleration sensor or a steering angle sensor) mounted to the vehicle VHm. The monitoring business may include a business of listening to sound information (for example, sound outside of the vehicle or a conversation among occupants) of the vehicle VHm acquired from a microphone (for example, an exterior microphone or an interior microphone) mounted to the vehicle VHm.

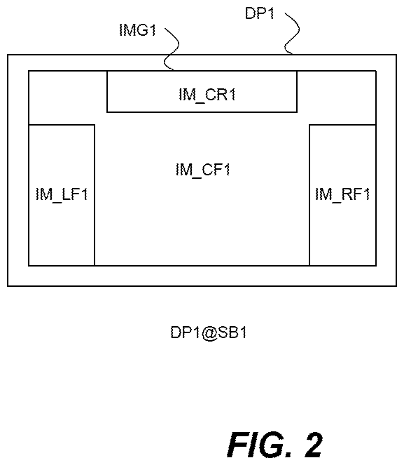

Images of a car-mounted camera, a recognition sensor, and the like which are monitored by the operator OP in the first and second businesses SB1 and SB2 are output from a display DPn of a terminal operated by the operator OPn. FIG. 2 is a diagram showing an example of an image IMG1 that is output from a display DP1 of a terminal operated by an operator OP1. In the example shown n FIG. 2, the image IMG1 includes an image IM_CF1. The image IM_CF1 is an image of center front of a vehicle VH1 acquired by a car-mounted camera of the vehicle VH1.

In addition, an image IM_LF1 is superimposed on a leftward portion of the image IM_CF1 and an image IM_RF1 is superimposed on a rightward portion of the image IM_CF1. The image IM_LF1 is an image of left front of the vehicle VH1 acquired by the car-mounted camera of the vehicle VH1, and the image IM_RF1 is an image of right front of the vehicle VH1 acquired by the car-mounted camera of the vehicle VH1. In addition, an image IM_CR1 is superimposed on an upward part of the image IM_CF1. The image IM_CR1 is an image of center rear of the vehicle VH1 acquired by the car-mounted camera of the vehicle VH1.

The image IMG1 shown in FIG. 2 corresponds to an image example output from the display DP1 when the operator OP1 performs the first business SB1. The image IMG1 may include a peripheral image of the vehicle VH1 (for example, an image of the side of the vehicle VH1) other than the images shown in FIG. 2. In addition, the display DP1 may be constituted of two or more displays. In this case, the images IM_LF1, IM_RF1, and IM_CR1 may be output from a display other than the display that outputs the image IM_CF1.

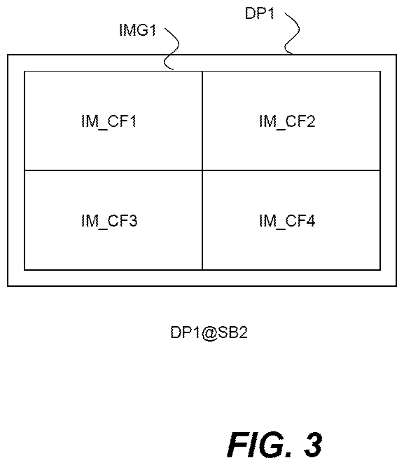

FIG. 3 is a diagram showing another example of the image IMG1 that is output from the display DP1 of the terminal operated by the operator OP1. The image IMG1 shown in FIG. 3 corresponds to an image example output from the display DP1 when the operator OP1 performs the second business SB2. In the example shown in FIG. 3, a display region of the display DP1 is divided into four regions and images IM_CF1 to IM_CF4 are respectively output to the regions. The images IM_CF2 to IM_CF4 are respective images of center front of vehicles VH2 to VH4 acquired by car-mounted cameras of the vehicles VH2 to VH4.

As is apparent from FIG. 3, the second business SB2 includes a business of monitoring peripheral images of two or more vehicles VH and concurrently verifying travel safety of the vehicles VH. This is because, while an operator OPn in charge of the first business SB1 of the vehicle VHm is expected to concentrate on the first business SB1 or forbidden to engage in service businesses SB other than the first business SB1, there are fewer such constraints with respect to the second business SB2. The example shown in FIG. 3 is merely an example and only information related to one vehicle (in other words, information related to the vehicle VHm) may be output from the display DPn during the second business SB2 by the operator OPn.

### 1-1-3. Start Trigger of Service Business SB

The service business SB by the operator OPn is started following an output of a trigger. Examples of an output source of a start trigger TRG of the service business SB include the vehicle VHm, the operator OPn, the management server MS, and an arbitrary predictor. Hereinafter, the output sources described above and output examples of the start trigger TRG by the output sources will be described.

The vehicle VHm performs recognition of an object included in a peripheral image of the vehicle VHm. In addition, the vehicle VHm performs detection of a motion of a recognized object. For example, when it is difficult to recognize an object included in the peripheral image, the vehicle VHm requests the management server MS to perform recognition of the object. At this point, the start trigger TRG is output. In another example, when recognition of an object has been performed but an unnatural motion of the object has been detected, the vehicle VHm requests the management server MS to perform verification of a state of the object. The start trigger TRG is also output at this point.

The vehicle VHm may perform recognition of a state of an occupant (driver) included in an interior image of the vehicle VHm. In addition, when an abnormal state of the driver is detected, the vehicle VHm may request the management server MS to perform verification of the abnormal state. The start trigger TRG is also output at this point. The vehicle VHm may perform detection of a motion of an object in a periphery of the vehicle VHm based on information from a recognition sensor other than a car-mounted camera. In addition, when an unnatural motion of the object has been detected, the vehicle VHm may request the management server MS to perform verification of a state of the object. The start trigger TRG is also output at this point.

The operator OPn on standby for a service business SB starts the second business SB2 to the vehicle VHm at an arbitrary timing. An example of the arbitrary timing is a timing at which the operator OPn starts the service business SB. Another example of the arbitrary timing is a timing at which the first business SB1 to the vehicle VHm by the operator OPn is brought to a close. In such a case, the operator OPn makes a request for the second business SB2 to the management server MS. At this point, the start trigger TRG is output.

When engaged in the second business SB2, the operator OPn monitors a peripheral image of at least one vehicle output from the display DPn. In addition, the operator OPn may monitor information other than a peripheral image (for example, an interior image, recognition sensor information, a traffic flow image, or travel information). Furthermore, the operator OPn can listen to information (in other words, sound information) related to at least one vehicle output from a speaker. In addition, during the second business SB2, when the operator OPn determines that the first business SB1 to a single given vehicle is necessary, the operator OPn makes a request for the service business SB to the management server MS. At this point, the start trigger TRG is output.

The output of the start trigger TRG can be detected by the management server MS. For example, when the vehicle VHm is the output source, the start trigger TRG is detected by having the management server MS receive a request signal for the service business SB from the vehicle VHm. When the operator OPn engaged in the second business SB2 is the output source, the start trigger TRG is detected by having the management server MS receive a request signal for the first business SB1 from the operator OPn.

The management server MS can appropriately acquire an image (for example, a peripheral image or an interior image) taken by the car-mounted camera of the vehicle VHm. Therefore, when an object recognition function or a driver state recognition function included in the vehicle VHm has been provided, the management server MS can perform recognition of an object included in a peripheral image of the vehicle VHm, detection of a motion of the recognized object, and recognition of a state of the driver of the vehicle VHm. In addition, the management server MS can appropriately acquire information (for example, recognition sensor information, a traffic flow image, travel information, and sound information) other than images taken by the car-mounted camera. Therefore, when a start determination function of the service business SM has been provided, the management server MS can actively output the start trigger TRG.

When the vehicle VHm is in operation, the management server MS may output the start trigger TRG of the second business SB2 to the vehicle VHm every time a predetermined period of time elapses. In addition, when the vehicle VHm is in operation, the management server MS may output the start trigger TRG of the second business SB2 to the vehicle VHm every time a cumulative travel distance of the vehicle VHm reaches a distance to be a delimiter. In addition, at the start of operation of the vehicle VHm or when the vehicle VHm is stopped, the management server MS may output the start trigger TRG of the first business SB1 in order to verify operations of various apparatuses (for example, verification of lighting) of the vehicle VHm. Furthermore, at the start of operation of the vehicle VHm or when the vehicle VHm is stopped, the management server MS may output the start trigger TRG of the second business SB2 in order to verify states (verification of tire air pressure, oil verification, battery verification, travel distance verification, or external appearance verification) of the vehicle VHm.

For example, the arbitrary predictor is formed inside the management server MS. The arbitrary predictor may be formed outside the management server MS. The arbitrary predictor predicts an occurrence of a service business SB to the vehicle VHm according to machine learning using a provision history (a time slot and a place) of the service business SB. The arbitrary predictor may predict an occurrence of a service business SB at a point of attention by an infrastructure sensor according to machine learning using the provision history of the service business SB. The point of attention by the infrastructure sensor is set based on, for example, a detection range of the infrastructure sensor and map information. When the occurrence of the service business SB is predicted, the arbitrary predictor formed inside the management server MS outputs the start trigger TRG. The arbitrary predictor formed outside of the management server MS transmits a signal corresponding to the start trigger TRG to the management server MS.

Hereinafter, for convenience of description, the start trigger TRG of the first business SB1 to the vehicle VHm will also be referred to as a “start trigger TRG_SB1” and the start trigger TRG of the second business SB2 to the vehicle VHm will also be referred to as a “start trigger TRG_SB2”.

### 1-2. Features of First Embodiment

When the start trigger TRG of the service business SB to the vehicle VHm has been output, the management server MS selects an operator OPn to which the service business SB is to be assigned from the plurality of operators OP. Hereinafter, for convenience of description, the operator OPn to which the service business SB has been assigned will also be referred to as an “operator OP_SB”. In addition, the operator OPn to which the first business SB1 is assigned will also be referred to as an “operator OP_SB1” and the operator OPn to which the second business SB2 is assigned will also be referred to as an “operator OP_SB2”.

Let us now consider the display DPn being monitored by a candidate of the operator OP_SB1 when the start trigger TRG_SB1 to the vehicle VHm has been output. An operator OPn standing by to engage in the service business SB and an operator OPn (in other words, the operator OP_SB2) engaged in the second business SB2 are assumed as candidates of the operator OP_SB1. The former is an operator OPn in a state of being capable of accepting the first business SB1 to be performed in accordance with the start trigger TRG_SB1 as a new service business SB. The latter is an operator OPn in a state of being capable of switching from the second business SB2 that the operator OPn is currently engaged in to the first business SB1 to be performed in accordance with the start trigger TRG_SB1.

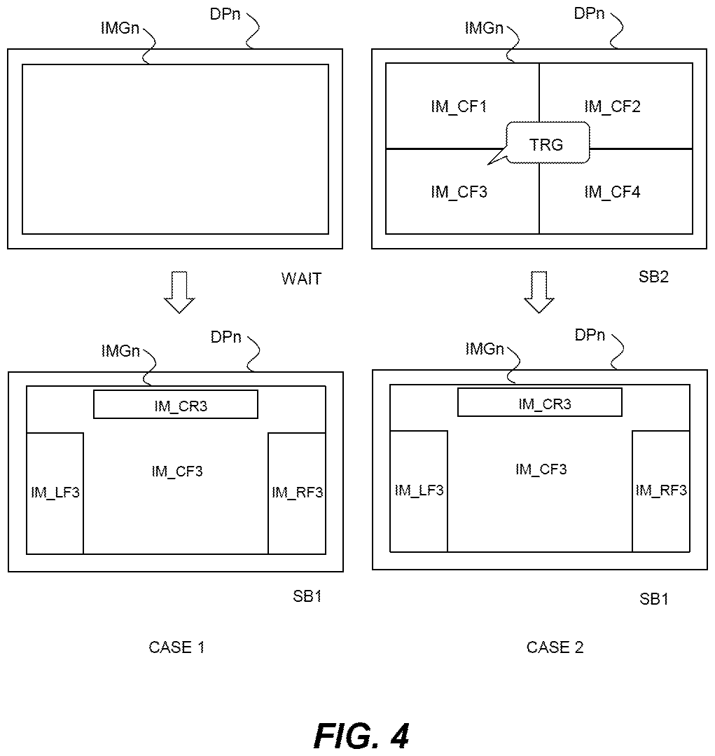

“CASE 1” shown in FIG. 4 represents an example of an image IMGn that is output from the display DPn when the first business SB1 to the vehicle VH3 is assigned to the operator OPn standing by to engage in the service business SB. “CASE 2” shown in FIG. 4 represents an example of an image IMGn that is output from the display DPn when the first business SB1 to the vehicle VH3 is assigned to the operator OPn engaged in the second business SB2 to the vehicle VH3.

When “CASE 1” and “CASE 2” are compared with each other, it is expected that the latter enables surroundings and the like of the vehicle VH3 to be comprehended more promptly than the former. This is because, since the operator OPn has already been engaged in the second business SB2 to the vehicle VH3 before being assigned the first business SB1 to the vehicle VH3, time will not be required to comprehend the surroundings and the like of the vehicle VH3.

Based on such a perspective, in the first embodiment, when the start trigger TRG_SB1 of the first business SB1 to the vehicle VHm is output, a determination is made as to whether or not there is an operator OPn already engaged in the second business SB2 to the vehicle VHm. In addition, when it is determined that there is an operator OPn already engaged in the second business SB2 to the vehicle VHm, the first business SB1 is preferentially assigned to the operator OPn. It is expected that a contribution is to be made towards smoothly running the remote service by performing such preferential assignments.

Hereinafter, the management method and the management apparatus according to the first embodiment will be described in greater detail.

### 1-3. Management Apparatus of Remote Service

### 1-3-1. Configuration Example

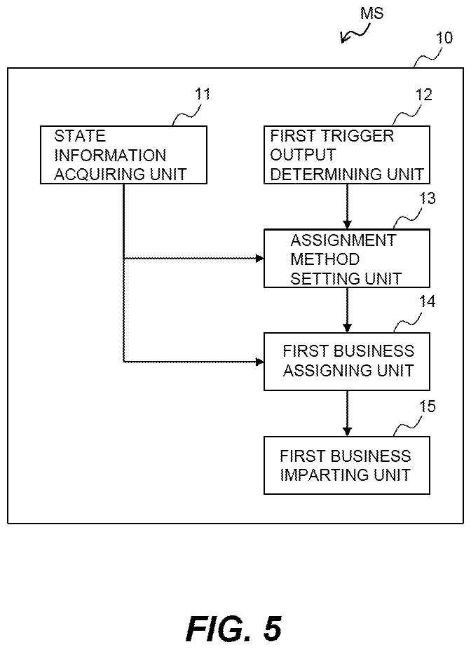

FIG. 5 is a block diagram showing a functional configuration example of a processor 10 of the management server MS particularly related to the first embodiment. In the example shown in FIG. 5, the processor 10 includes a state information acquiring unit 11, a first trigger output determining unit 12, an assignment method setting unit 13, a first business assigning unit 14, and a first business imparting unit 15. Each function of the blocks is realized as the processor 10 executes a remote service program.

The state information acquiring unit 11 acquires information related to a present state of the plurality of vehicles VH and the plurality of operators OP. For example, information related to the present state of the plurality of vehicles VH includes information on an operating state and information on a provision state of the service business SB. The operating state is divided into a state where a drive source (for example, a motor or an engine) of the vehicle VHm is in operation and a state where the drive source is not in operation. The provision state is divided into a state where the service business SB is being provided and a state where the service business SB is not being provided. When the service business SB is being provided to the vehicle VHm, information on a type (in other words, the first business SB1 and the second business SB2) of the service business SB being provided is added to the information on the provision state.

Information related to the present state of the plurality of operators OP includes information on an engagement state to the service business SB. The engagement state is divided into a state of standby for engagement in the service business SB and a state of being engaged in the service business SB. When the operator OPn is engaged in the service business SB, information on a type (in other words, the first business SB1 and the second business SB2) of the service business SB that the operator OPn is engaged in is added to the information on the present state. When the operator OPn is engaged in the service business SB, unique information (for example, ID information) of an object of the service business SB (hereinafter, also referred to as a “vehicle VH_SB”) is added to the information on the engagement state. As will be understood from the description of FIG. 3, the total number of objects of the second business SB2 (hereinafter, also referred to as a “vehicle VH_SB2”) is at least one.

The state information acquiring unit 11 transmits information related to the present state acquired by the state information acquiring unit 11 to the assignment method setting unit 13 and the first business assigning unit 14.

The first trigger output determining unit 12 determines whether or not a start trigger TRG_SB1 to the vehicle VHm has been output. As already described, output sources of the start trigger TRG include the vehicle VHm, the operator OPn, the management server MS, and an arbitrary predictor. When the output of the start trigger TRG_SB1 is detected, the first trigger output determining unit 12 transmits unique information (for example, ID information) of the vehicle (hereinafter, also referred to as a “vehicle VH_TRG_SB1”) having output the start trigger TRG_SB1 to the assignment method setting unit 13.

The assignment method setting unit 13 sets, based on information related to the present state of the plurality of vehicles VH received from the state information acquiring unit 11 and unique information of the vehicle VH_TRG_SB1 received from the first trigger output determining unit 12, an assignment method of the first business SB1 to the vehicle VH_TRG_SB1. Specifically, the assignment method setting unit 13 determines whether or not the vehicle VH_TRG_SB1 is included in the present object (in other words, the vehicle VH_SB2) of the second business SB2. The determination is made by collating the unique information of the vehicle VH_TRG_SB1 with the unique information of the vehicle VH_SB2.

When it is determined that the vehicle VH_TRG_SB1 is included in the vehicle VH_SB2, “preferential assignment” is set as the assignment method. When it is determined that the vehicle VH_TRG_SB1 is not included in the vehicle VH_SB2, “regular assignment” is set as the assignment method. The assignment method setting unit 13 transmits information on the set assignment method and the unique information of the vehicle VH_TRG_SB1 to the first business assigning unit 14.

The first business assigning unit 14 selects, based on information related to the present state of the plurality of operators OP received from the state information acquiring unit 11 and information on an assignment method and the unique information of the vehicle VH_TRG_SB1 received from the assignment method setting unit 13, an operator OPn to be placed in charge of the first business SB1 to the vehicle VH_TRG_SB1.

Let us consider a case where “preferential assignment” is set as the assignment method. In this case, based on the information related to the present state of the plurality of operators OP and the unique information of the vehicle VH_TRG_SB1, an operator OP_SB2 already engaged in the second business SB2 to the vehicle VH_TRG_SB1 is specified. The specified operator OP_SB2 is selected as the operator OP_SB1 to be placed in charge of the first business SB1 to the vehicle VH_TRG_SB1.

Let us consider a case where “regular assignment” is set as the assignment method. In this case, for example, based on information related to the present state of the plurality of operators OP, a plurality of operators OP on standby for the service business SB are set as candidates of the operator OP_SB1. In addition, an operator to be placed in charge of the first business SB1 to the vehicle VH_TRG_SB1 is selected from among the candidates.

Note that known methods can be applied as a selection method of the operator OP_SB1 in a case where “regular assignment” is set. For example, according to a known method, candidates of the operator OP_SB1 may be narrowed down based on a length of a standby time (operating rate) for the service business SB, proficiency (frequency of experience) in the service business SB, and the like of the candidates.

The first business imparting unit 15 transmits information necessary to start the first business SB1 to the vehicle VH_TRG_SB1 to the terminal operated by the operator OP_SB1 selected by the first business assigning unit 14. Examples of the information necessary to start the first business SB1 include a peripheral image of the vehicle VH_TRG_SB1.

In addition, the first business imparting unit 15 transmits, to the terminal, information notifying that a transition has been made from the second business SB2 to the vehicle VH_TRG_SB1 to the first business SB1 to the vehicle VH_TRG_SB1. The first business imparting unit 15 further transmits, to the terminal, information which enables an operation of apparatuses (for example, the steering wheel, pedals, the gear shift, and turn signals) related to travel of the vehicle VH_TRG_SB1.

Furthermore, when the operator OP_SB1 is selected by the first business assigning unit 14, the first business imparting unit 15 updates information related to the present state of the operator OP_SB1. Specifically, information on a type of service business SB that the operator OP_SB1 is engaged in is updated. Furthermore, when the first business SB1 by the operator OP_SB1 is started, the first business imparting unit 15 updates information related to the present state of the plurality of vehicles VH. Specifically, information on a type of service business SB being provided is updated.

### 1-3-2. Processing Example

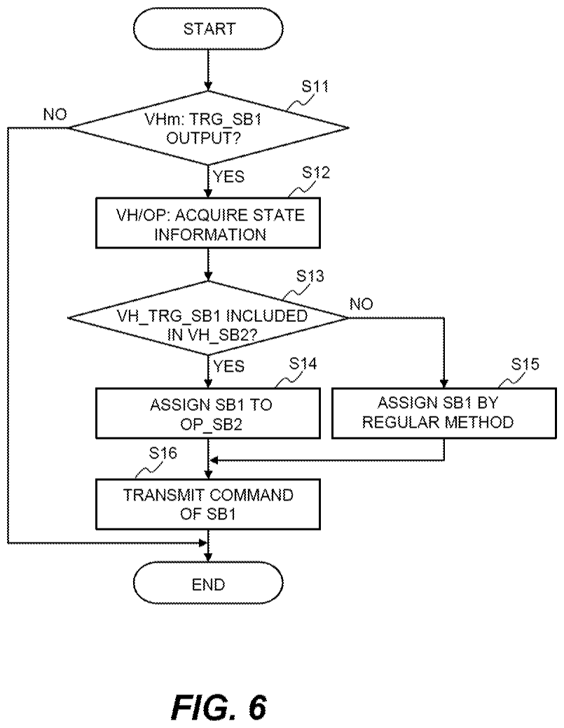

FIG. 6 is a flow chart showing a flow of processing particularly related to the first embodiment by the management server MS (processor 10). The routine shown in FIG. 6 is repetitively executed in, for example, predetermined control cycles.

In the routine shown in FIG. 6, first, whether or not the start trigger TRG_SB1 has been output is determined (step S11). For example, when the processor 10 receives a predetermined signal from the output source of the start trigger TRG, it is determined that the start trigger TRG_SB1 has been output. When the determination result of step S11 is negative, the present processing is brought to a close.

When the determination result of step S11 is positive, information related to a present state of the plurality of vehicles VH and the plurality of operators OP is acquired (step S12). Information related to the present state is stored in, for example, a database of the management server MS and the processor 10 acquires latest information from the database.

Following the processing in step S12, whether or not the vehicle (in other words, the vehicle VH_TRG_SB1) having output the start trigger TRG_SB1 is included in the present object (in other words, the vehicle VH_SB2) of the second business SB2 is determined (step S13). The determination of step S13 is made by, for example, collating the unique information of the vehicle VH_TRG_SB1 with the unique information of the vehicle VH_SB2.

When the determination result of step S13 is positive, the first business SB1 to the vehicle VH_TRG_SB1 is assigned to the operator OP_SB2 engaged in the second business SB2 to the vehicle VH_TRG_SB1 (step S14). On the other hand, when the determination result of step S13 is negative, assignment of the first business SB1 is performed according to a known method (step S15). In step S15, for example, a plurality of operators OP on standby for the service business SB are considered candidates of the operator OP_SB1 and a single operator is selected from among the candidates. In addition, the first business SB1 to the vehicle VH_TRG_SB1 is assigned to the selected operator.

Following the processing in step S14 or S15, an execution command of the first business SB1 to the vehicle VH_TRG_SB1 is transmitted to a computer of the selected operator (step S16). The execution command includes information necessary for starting the first business SB1, information notifying that a transition has been made to the first business SB1, and information which enables operations of apparatuses related to travel of the vehicle VH_TRG_SB1.

### 1-4. Effects

According to the first embodiment described above, in the event where the start trigger TRG_SB1 to the vehicle VHm is output, when there is an operator OPn already engaged in the second business SB2 to the vehicle VH_TRG_SB1, the first business SB1 to the vehicle VH_TRG_SB1 is assigned to the operator OPn. Therefore, the time required by the operator OP to comprehend surroundings of the vehicle VH_TRG_SB1 and the like can be reduced. It is expected that a contribution is to be made towards smoothly running the remote service by such a reduction in comprehension time.

### 2. Second Embodiment

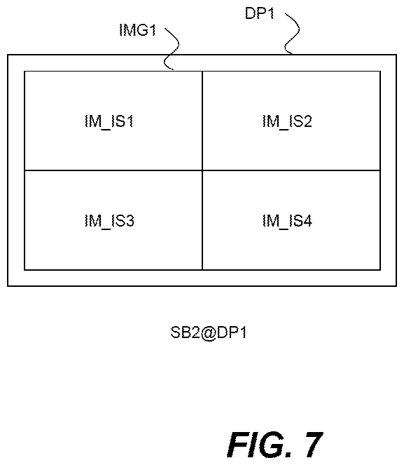

Next, a second embodiment of the present disclosure will be described with reference to FIGS. 7 to 9. Descriptions overlapping with the descriptions of the first embodiment will be omitted when appropriate.

### 2-1. Features of Second Embodiment

FIG. 7 is a diagram showing yet another example of the image IMG1 that is output from the display DP1 of the terminal operated by the operator OP1. The image IMG1 shown in FIG. 7 corresponds to an image example output from the display DP1 when the operator OP1 performs the second business SB2. In the example shown in FIG. 7, a display region of the display DP1 is divided into four regions. So far, the example shown in FIG. 7 is the same as the example shown in FIG. 3. In the example shown in FIG. 7, images IM_IS1 to IS4 are respectively output to the regions of the display DP1. The images IM_IS1 to IS4 are images respectively acquired by four infrastructure sensors.

In the second embodiment, a case of mainly performing the second business SB2 of monitoring an image of a traffic flow acquired from an infrastructure sensor will be considered. The management server MS and an arbitrary predictor are assumed as an output source of a start trigger TRG of the second business SB2 of monitoring an image of a traffic flow. Since an installation position of the infrastructure sensor is known, the start trigger TRG of the second business SB2 is conceivably output by an operator OPn standing by for a service business SB by selecting a specific infrastructure sensor.

The start trigger TRG of the first business SB1 (in other words, the start trigger TRG_SB1) to the vehicle VHm described in the first embodiment can be output while the operator OPn is engaged in the second business SB2 of monitoring an image of a traffic flow. The vehicle VHm, the management server MS, and an arbitrary predictor are assumed as the output source of the start trigger TRG_SB1. While the operator OPn may become the output source of the start trigger TRG_SB1 when the operator OPn is engaged in the second business SB2 of monitoring a peripheral image of the vehicle VHm acquired from the car-mounted camera of the vehicle VHm, this case will not be considered in the second embodiment.

When the operator OPn is engaged in the second business SB2 of monitoring a peripheral image of the vehicle VHm, information of an object (in other words, the vehicle VH_SB2) of the second business SB2 can be acquired from the information related to the present state of the plurality of operators OP. In the first embodiment, based on the information on the vehicle VH_SB2, a determination is made as to whether or not there is an operator OPn already engaged in the second business SB2 to the vehicle VH_TRG_SB1.

However, when the operator OPn is engaged in the second business SB2 of monitoring an image of an infrastructure sensor, the operator OPn is conceivably engaged in the second business SB2 without recognizing at what position in the image of the infrastructure sensor an image of the vehicle VH_SB2 is present. In addition, in the first embodiment, a position in an image of an infrastructure sensor where an image of the vehicle VH_SB2 is present is not specified. Therefore, with a referral method according to the first embodiment, it is difficult to specify information of an object (in other words, the vehicle VH_SB2) of the second business SB2 based on an image of an infrastructure sensor.

Supposing that coordinate information indicating at what position in an image of an infrastructure sensor an image of the vehicle VH_SB2 is present has been calculated in advance and the coordinate information has been added to information related to the present state (more specifically, information on the engagement state) of a plurality of operators OP, information on the vehicle VH_SB2 can be specified. However, there may also be cases where the preliminary calculation of the coordinate information is intentionally not performed. Examples of reasons for not performing the preliminary calculation of the coordinate information include reducing processing load for calculating the coordinate information, suppressing an increasing in communication load accompanying constant transmission of information related to the present state of the plurality of operators OP, and refraining from constantly transmitting information related to the present state of the plurality of vehicles VH prior to output of the start trigger TRG from the perspective of privacy protection.

When the preliminary calculation of the coordinate information is intentionally not performed, the information of the vehicle VH_SB2 cannot be specified. In consideration thereof, in the second embodiment, when the start trigger TRG_SB1 to the vehicle VHm is output, a referral to an operator OPn already engaged in the second business SB2 based on an image of an infrastructure sensor is performed using a combination of information which differs from the combination information used when setting the assignment method described in the first embodiment.

In a first referral method according to the second embodiment, whether or not the vehicle VH_SB2 is being monitored by the second business SB2 based on an image of an infrastructure sensor is determined based on unique information of the vehicle VH_TRG_SB1, unique information of the vehicle VH_SB2, and coordinate information of the vehicle VH_TRG_SB1 in the image of the infrastructure sensor.

In a second referral method according to the second embodiment, the determination described above is performed based on unique information of the vehicle VH_TRG_SB1, position information and azimuth information of the vehicle VH_TRG_SB1, and position information and angle-of-view information of the infrastructure sensor (camera). In other words, in the second referral method, the position information and the azimuth information of the vehicle VH_TRG_SB1 and the position information and the angle-of-view information of the infrastructure sensor (camera) have been added to the unique information of the vehicle VH_TRG_SB1 used when setting the assignment method described in the first embodiment. The former information is acquired from, for example, a GPS sensor mounted to the vehicle VH_TRG_SB1. As the latter information, information set or registered in advance is used.

In the second referral method, the vehicle VH_TRG_SB1 may communicate with the infrastructure sensor (camera) and verification information regarding whether or not the vehicle VH_TRG_SB1 is included in a range of an angle of view of the infrastructure sensor may be further added. In addition, in the second referral method, collation of color information of a vehicle body of the vehicle VH_TRG_SB1 and color information of an object recognized in the image of the infrastructure sensor (camera) may be supplementarily performed. In the case of an infrastructure sensor (infrared sensor), infrared light may be emitted from a car-mounted apparatus of the vehicle VH_TRG_SB1 at a predetermined emission pattern and, accordingly, verification information of whether or not the vehicle VH_TRG_SB1 is included in a recognition range of the infrastructure sensor may be generated. When the vehicle VH_TRG_SB1 includes LiDAR, irradiated light from LiDAR may be used instead of emitting infrared light.

In a third referral method according to the second embodiment, same additional information as the second referral method is used. However, unlike the second referral method, the third referral method is premised on a server which manages position information and angle-of-view information of the infrastructure sensor (camera) being present separately from the management server MS. In this case, the management server MS may conceivably request information on the infrastructure sensor to the server which manages the information. In addition, when the information on the infrastructure sensor is provided in response to the request, the determination described above is performed by a similar method to the second referral method.

In the second and third referral methods, the infrastructure sensor which communicates with the vehicle VH_TRG_SB1 may generate verification information regarding whether or not the vehicle VH_TRG_SB1 is included in a range of an angle of view of the infrastructure sensor. In this case, the management server MS is provided with the verification information from the infrastructure sensor instead of from the vehicle VH_TRG_SB1.

Hereinafter, the management method and the management apparatus according to the second embodiment will be described in greater detail.

### 2-2. Management Apparatus of Remote Service

### 2-2-1. Configuration Example

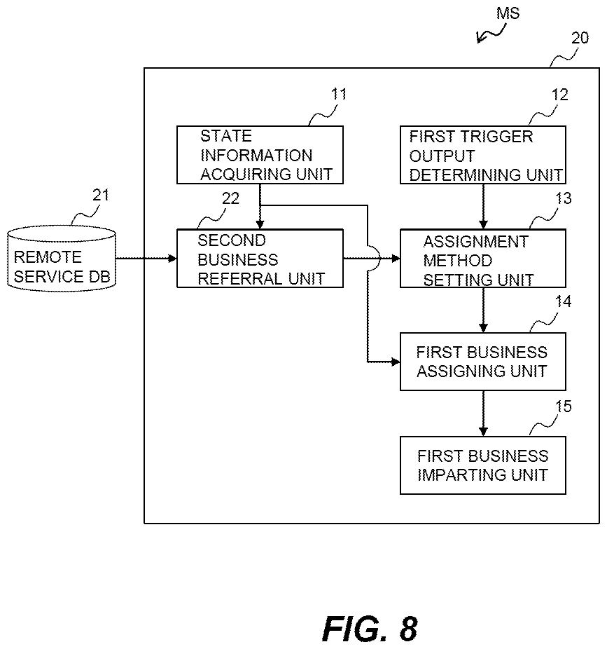

FIG. 8 is a block diagram showing a configuration example of the management server MS particularly related to the second embodiment. In the example shown in FIG. 8, the management server MS includes a processor 20 and a remote service DB (database) 21.

The processor 20 includes the functional units 11 to 15 described with reference to FIG. 5 and a second business referral unit 22. In the second embodiment, information related to a present state of a plurality of operators OP is transmitted from the state information acquiring unit 11 to the second business referral unit 22. Based on the information related to the present state and the information stored in the remote service DB 21, the second business referral unit 22 determines whether or not there is an operator OPn engaged in the second business SB2 to the vehicle VH_TRG_SB1. In addition, the second business referral unit 22 transmits the determination result to the assignment method setting unit 13.

In the second embodiment, an assignment method is set by the assignment method setting unit 13 based on the determination result received from the second business referral unit 22. Specifically, “preferential assignment” is set as the assignment method when the determination result is positive. “Regular assignment” is set as the assignment method when the determination result is negative.

The remote service DB 21 stores information related to a present state of the plurality of vehicles VH and the plurality of operators OP. Information in the remote service DB 21 is regularly updated. Past information in the remote service DB 21 is also stored in the remote service DB 21 for a certain period of time. When coordinate information of the vehicle VH_TRG_SB1 in an image of an infrastructure sensor has been calculated, the coordinate information is stored in the remote service DB 21 as a part of the information related to the present state of the plurality of operators OP.

When position information and azimuth information of the vehicle VH_TRG_SB1 have been acquired, the vehicle information is stored in the remote service DB 21 as a part of the information related to the present state of the plurality of vehicles VH. When verification information on whether or not the vehicle VH_TRG_SB1 is included in a range of the angle of view of the infrastructure sensor has been generated, the verification information is stored in the remote service DB 21 as a part of the information related to the present state of the plurality of vehicles VH.

When position information and the like of the infrastructure sensor have been set or registered in advance, the infrastructure sensor information is stored in the remote service DB 21. When position information and the like of the infrastructure sensor have been provided by a server that manages information on the infrastructure sensor, the infrastructure sensor information is also stored in the remote service DB 21.

### 2-2-2. Processing Example

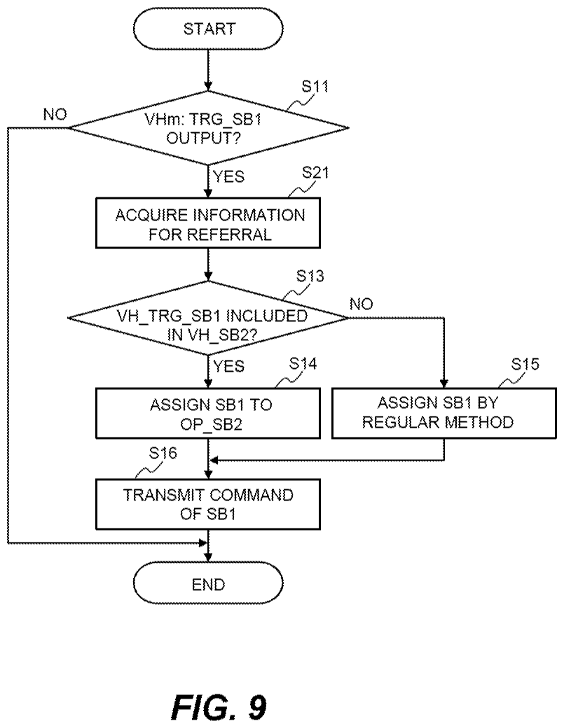

FIG. 9 is a flow chart showing a flow of processing particularly related to the second embodiment by the management server MS (processor 20). The routine shown in FIG. 9 is repetitively executed in, for example, predetermined control cycles.

A basic flow of the routine shown in FIG. 9 is the same as the routine described with reference to FIG. 6. The difference between the routines is that processing of step S21 is performed in place of the processing of step S12. In other words, in the routine shown in FIG. 9, in step S21, information necessary for the first to third referral methods described above is acquired as “information for referral”. In addition, in the routine shown in FIG. 9, whether or not the vehicle VH_TRG_SB1 is included in the vehicle VH_SB2 is determined based on the information for referral (step S13).

### 2-3. Effects

According to the second embodiment described above, in the event where the start trigger TRG_SB1 to the vehicle VHm is output, when there is an operator OPn performing the second business SB2 to the vehicle VH_TRG_SB1 based on an image of a traffic flow acquired from an infrastructure sensor, the first business SB1 to the vehicle VH_TRG_SB1 can be assigned to the operator OPn. Therefore, a same advantageous effect as the advantageous effect obtained by the first embodiment can be obtained.

### 3. Third Embodiment

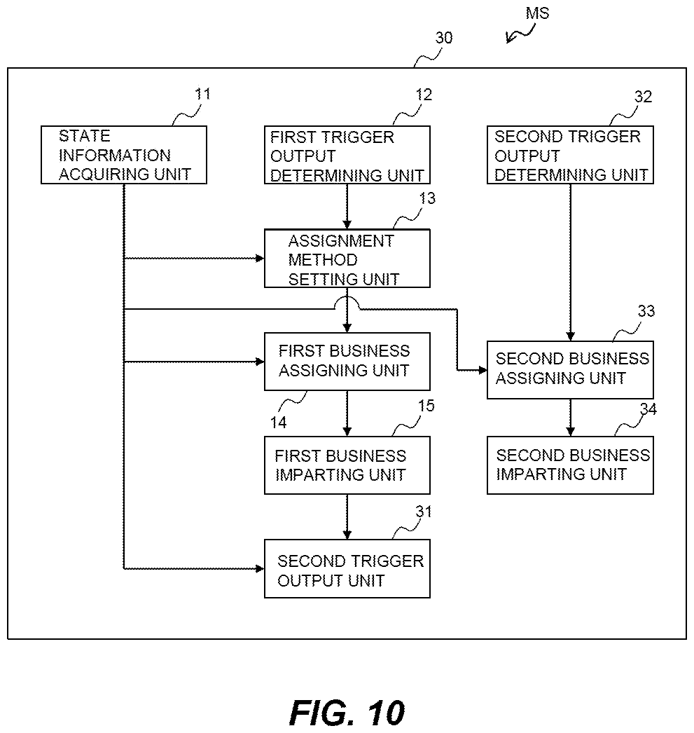

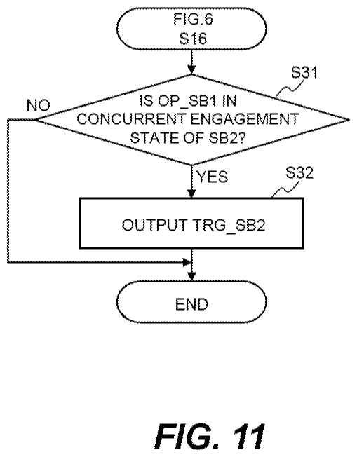

Next, a third embodiment of the present disclosure will be described with reference to FIGS. 10 and 11. Descriptions overlapping with the descriptions of the first and second embodiment will be omitted when appropriate.

### 3-1. Features of Third Embodiment

In the first and second embodiments, when there is an operator OPn already engaged in the second business SB2 to the vehicle VH_TRG_SB1, processing for assigning the first business SB1 to the vehicle VH_TRG_SB1 to the operator OPn is performed. In other words, processing for causing an operator OPn engaged in the second business SB2 to the vehicle VH_TRG_SB1 to take charge of the first business SB1 to the vehicle is performed. Therefore, when the processing is performed, the second business SB2 to the vehicle VH_TRG_SB1 by the operator OPn is brought to a close.

Let us now consider a case where the total number of objects (in other words, the vehicle VH_SB2) of the second business SB2 by the operator OPn prior to the assignment being performed is two or more. In other words, let us consider a case where, prior to the assignment being performed, the operator OPn has concurrently performed the second business SB2 to two or more vehicles VH_SB2. In this case, one vehicle among the two or more vehicles VH_SB2 is the vehicle VH_TRG_SB1. Therefore, when the first business SB1 to the vehicle VH_TRG_SB1 is started, the second business SB2 to the remaining vehicles VH_SB2 having been objects of the second business SB2 together with the vehicle VH_TRG_SB1 is to be brought to a close.

In consideration thereof, in the third embodiment, when an operator OPn having been engaged in the second business SB2 to two or more vehicles VH_SB2 including the vehicle VH_TRG_SB1 is selected as the operator to take charge of the first business SB1 to the vehicle VH_TRG_SB1, the start trigger TRG of the second business SB2 to the remaining vehicles VH_SB2 is output. When the start trigger TRG is output, an assignment of the second business SB2 to the vehicle (hereinafter, also referred to as a “vehicle VH_TRG_SB2”) having output the start trigger TRG is performed. Therefore, according to the third embodiment, the first business SB1 to the vehicle VH_TRG_SB1 can be started while continuing the second business SB2 to the remaining vehicles VH_SB2.

### 3-2. Management Apparatus of Remote Service

### 3-2-1. Configuration Example

FIG. 10 is a block diagram showing a functional configuration example of a processor 30 of the management server MS particularly related to the third embodiment. In the example shown in FIG. 10, the processor 30 includes the functional units 11 to 15 described with reference to FIG. 5, a second trigger output unit 31, a second trigger output determining unit 32, a second business assigning unit 33, and a second business imparting unit 34. In the third embodiment, information related to a present state of a plurality of operators OP is transmitted from the state information acquiring unit 11 to the second business assigning unit 33.

The second trigger output unit 31 outputs a start trigger TRG_SB2 to the vehicle VHm. In the third embodiment, information related to a present state of a plurality of operators OP is transmitted from the state information acquiring unit 11 to the second trigger output unit 31. In addition, in the third embodiment, information on an operator OP_SB1 selected by the first business assigning unit 14 and information on the vehicle VH_TRG_SB1 of which the operator OP_SB1 is to take charge are transmitted from the first business imparting unit 15 to the second trigger output unit 31.

When the second trigger output unit 31 receives information from the first business imparting unit 15, the second trigger output unit 31 refers to unique information (for example, ID information) of the operator OP_SB1 selected by the first business assigning unit 14 and extracts information related to the present state of the operator OP_SB1 from the information related to the present state of the plurality of operators OP. In addition, based on the extracted information related to the present state (specifically, information on an engagement state to the service business SB), the second trigger output unit 31 determines whether or not the engagement state of the operator OP_SB1 immediately preceding the selection by the first business assigning unit 14 is a concurrent engagement state of the second business SB2 to two or more vehicles VH_SB2.

In addition, when the engagement state of the operator OP_SB1 immediately preceding the selection by the first business assigning unit 14 is determined to be a concurrent engagement state of the second business SB2 to two or more vehicles VH_SB2, the second trigger output unit 31 specifies the remaining vehicles VH_SB2 having been objects of the second business SB2 together with the vehicle VH_TRG_SB1. Specification of the remaining vehicles VH_SB2 is performed based on, for example, information received from the first business imparting unit 15 (specifically, unique information of the vehicle VH_TRG_SB1) and information related to the present state of the plurality of operators OP (specifically, information related to the present state of the operator OPn selected by the first business assigning unit 14). The second trigger output unit 31 outputs the start trigger TRG of the second business SB2 to the specified remaining vehicles VH_SB2.

The second trigger output determining unit 32 determines whether or not a start trigger TRG_SB2 to the vehicle VHm has been output. As already described, output sources of the start trigger TRG include the vehicle VHm, the operator OPn, the management server MS, and an arbitrary predictor. In particular, in the third embodiment, the start trigger TRG of the second business SB2 to the remaining vehicles VH_SB2 having been concurrently performed with the vehicle VH_TRG_SB1 may be output. When the output of the start trigger TRG_SB2 is detected, the second trigger output determining unit 32 transmits unique information (for example, ID information) of the vehicle (in other words, the vehicle VH_TRG_SB2) having output the start trigger TRG_SB2 to the second business assigning unit 33.

The second business assigning unit 33 selects, based on information related to the present state of the plurality of operators OP received from the state information acquiring unit 11 and unique information of the vehicle VH_TRG_SB2 received from the second trigger output determining unit 32, an operator OPn to be assigned the second business SB2 to the vehicle VH_TRG_SB2.

The assignment of the second business SB2 is performed by, for example, “regular assignment” having been used when assigning the first business SB1. In this case, based on information related to the present state of a plurality of operators OP, a plurality of operators OP on standby for the service business SB are set as candidates of the operator OP_SB2. In addition, an operator to be assigned the second business SB2 to the vehicle VH_TRG_SB2 is selected from among the candidates. The unique information of the vehicle VH_TRG_SB2 may or may not be used when assigning the second business SB2. For example, when candidates of the operator OP_SB2 are to be narrowed down based on proficiency of the service business SB, the unique information of the vehicle VH_TRG_SB2 is used to calculate the proficiency.

The second business imparting unit 34 transmits information necessary to start the second business SB2 to the vehicle VH_TRG_SB2 to the terminal operated by the operator OP_SB2 selected by the second business assigning unit 33. Examples of the information necessary to start the second business SB2 include a peripheral image of the vehicle VH_TRG_SB2. Furthermore, when the operator OP_SB2 is selected by the second business assigning unit 33, the second business imparting unit 34 updates information related to the present state of the plurality of operators OP. In addition, when the second business SB2 by the operator OP_SB2 is started, the second business imparting unit 34 updates information related to the present state of the plurality of vehicles VH.

### 3-2-2. Processing Example

FIG. 11 is a flow chart showing a flow of processing particularly related to the third embodiment by the management server MS (processor 30). The routine shown in FIG. 11 is executed following the processing of step S16 in FIG. 6.

In the routine shown in FIG. 11, first, a determination is made as to whether or not the operator OPn (in other words, the operator OP_SB1) in charge of the first business SB1 to the vehicle VH_TRG_SB1 had been in a concurrent engagement state of the second business SB2 to two or more vehicles VH_SB2 immediately preceding the start of the first business SB1 (step S31). The determination of step S31 is performed based on, for example, information of the operator OPn in charge of the first business SB1 to the vehicle VH_TRG_SB1, information on the vehicle VH_TRG_SB1, and information on an engagement state to the service business SB of the operator OPn. When the determination result of step S31 is negative, the present processing is brought to a close.

When the determination result of step S31 is positive, the start trigger TRG (in other words, the start trigger TRG_SB2) to the remaining vehicles VH_SB2 having been objects of the second business SB2 together with the vehicle VH_TRG_SB1 is output (step S32).

### 3-3. Effects

According to the third embodiment described above, in a case where an operator OPn is concurrently engaged in the second business SB2 to two or more vehicles VH_SB2, when the first business SB1 to the vehicle VH_TRG_SB1 is assigned to the operator OPn, the start trigger TRG of the second business SB2 to the remaining vehicles VH_SB2 having been concurrently performed with the vehicle VH_TRG_SB1 can be output. Therefore, the first business SB1 to the vehicle VH_TRG_SB1 can be started while smoothly handing over the second business SB2 to the remaining vehicles VH_SB2 to another operator.

### 4. Fourth Embodiment

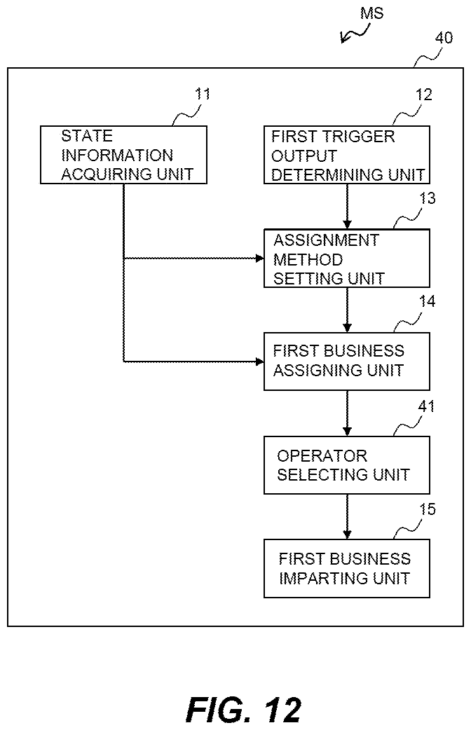

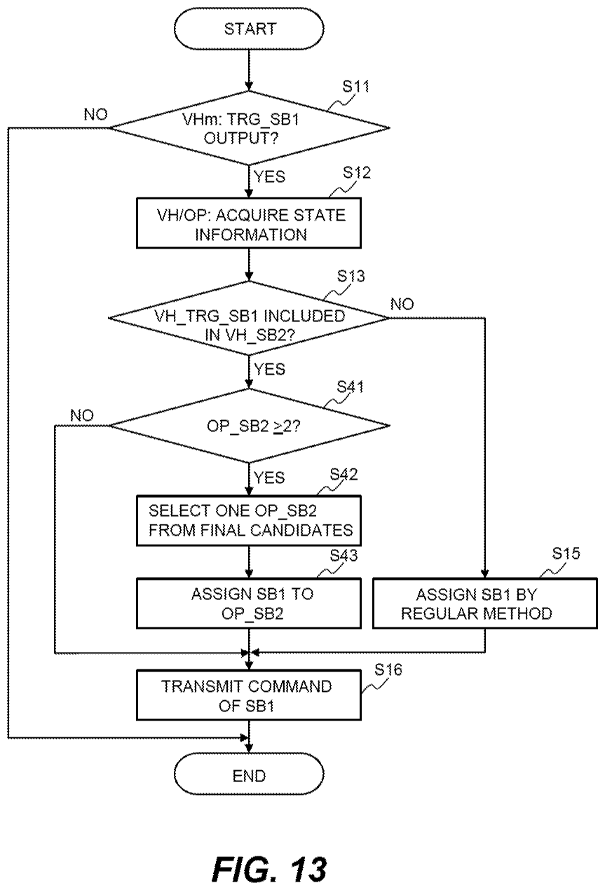

Next, a fourth embodiment of the present disclosure will be described with reference to FIGS. 12 and 13. Descriptions overlapping with the descriptions of the first to third embodiments will be omitted when appropriate.

### 4-1. Features of Fourth Embodiment

In the first and second embodiments, when there is an operator OPn already engaged in the second business SB2 to the vehicle VH_TRG_SB1, processing for assigning the first business SB1 to the vehicle VH_TRG_SB1 to the operator OPn is performed. In other words, in the first and second embodiments, when there is even one operator OPn already engaged in the second business SB2 to the vehicle VH_TRG_SB1, the first business SB1 to the vehicle VH_TRG_SB1 is assigned to the operator OPn.

However, as is understandable from the definition of the second business SB2, the total number of operators already engaged in the second business SB2 to the vehicle VH_TRG_SB1 may be two or more. In this case, which operator is to be assigned the first business SB1 to the vehicle VH_TRG_SB1 becomes an issue. In consideration thereof, in the fourth embodiment, one operator to which the first business SB1 to the vehicle VH_TRG_SB1 is to be assigned in such a case is selected.

While a selection method of the operator is not particularly limited, candidates of the operator OP_SB1 are desirably narrowed down based on a certain selection criterion. Examples of the selection criterion will be described later. Selecting an operator enables the first business SB1 to the vehicle VH_TRG_SB1 to be reliably assigned to a single operator when the total number of operators OPn engaged in the second business SB2 to the vehicle VH_TRG_SB1 is two or more.

### 4-2. Management Apparatus of Remote Service

### 4-2-1. Configuration Example

FIG. 12 is a block diagram showing a functional configuration example of a processor 40 of the management server MS particularly related to the fourth embodiment. In the example shown in FIG. 12, the processor 40 includes the functional units 11 to 15 described with reference to FIG. 5 and an operator selecting unit 41.

In the fourth embodiment, the first business assigning unit 14 selects an operator OPn to be in charge of the first business SB1 to the vehicle VH_TRG_SB1. So far, the fourth embodiment is the same as the first embodiment. In the fourth embodiment, when the total number of operators in charge of the second business SB2 to the vehicle VH_TRG_SB1 is two or more, the first business assigning unit 14 selects these operators as final candidates of the operator OP_SB1. The final candidates of the operator OP_SB1 are transmitted to the operator selecting unit 41.

The operator selecting unit 41 selects a single operator from the final candidates of the operator OP_SB1 received from the first business assigning unit 14. A first example of the selection criterion involves an output source of the start trigger TRG_SB1. When a final candidate of the operator OP_SB1 corresponds to an output source of the start trigger TRG_SB1, it is highly likely that the final candidate comprehends a cause, a reason, or the like for starting the first business SB1 to the vehicle VH_TRG_SB1. Therefore, in the first example, when a final candidate of the operator OP_SB1 is an output source of the start trigger TRG_SB1, the final candidate is selected as the operator OP_SB1.

A second example of the selection criterion involves a duration of the second business SB2 to the vehicle VH_TRG_SB1. It is expected that the longer the duration of the second business SB2 to the vehicle VH_TRG_SB1, the higher the degree of comprehension of surroundings and the like of the vehicle VH_TRG_SB1. Therefore, in the second example, a final candidate with a longest duration of the second business SB2 to the vehicle VH_TRG_SB1 is selected as the operator OP_SB1.

A third example of the selection criterion involves a type of an image used by a final candidate of the operator OP_SB1 to recognize the vehicle VH_TRG_SB1. The image monitored by the operator OP_SB1 in the first business SB1 is a peripheral image of the vehicle VH_TRG_SB1. Therefore, it is expected that a final candidate monitoring a peripheral image of the vehicle VH_TRG_SB1 comprehends the surroundings and the like of the vehicle VH_TRG_SB1 in a shorter period of time than a final candidate monitoring an image of an infrastructure sensor including an image of the vehicle VH_TRG_SB1. Therefore, in the third example, a final candidate operating a terminal in which a peripheral image of the vehicle VH_TRG_SB1 is output on a display is selected as the operator OP_SB1.

A fourth example of the selection criterion is an opposite of the third example. It is expected that a final candidate monitoring an image of an infrastructure sensor comprehends an entire surrounding environment of the vehicle VH_TRG_SB1 and is, therefore, able to comprehend the surroundings and the like of the vehicle VH_TRG_SB1 in a short period of time. Therefore, in the fourth example, a final candidate operating a terminal in which an image of an infrastructure sensor is output on a display is selected as the operator OP_SB1.

A fifth example of the selection criterion involves a communication band used by a final candidate at a time point where selection is performed. When there is superiority or inferiority among communication bands, it is expected that a final candidate using a superior communication band is to comprehend the surroundings and the like of the vehicle VH_TRG_SB1 in a short period of time. Therefore, in the fifth example, a final candidate using the most superior communication band is selected as the operator OP_SB1. Note that a communication band can be assessed based on a communication speed, a communication delay time, a fluctuation in the communication delay time, and the like between a terminal operated by the final candidate and the management server MS.

A sixth example of the selection criterion involves an object of attention in the first business SB1. An object of attention in the first business SB1 is an object having caused the first business SB1 to the vehicle VH_TRG_SB1 to be started. When information related to an object of attention is also output when the start trigger TRG is output, it is expected that a final candidate monitoring a peripheral image of the vehicle VH_TRG_SB1 including an image of the object of attention or an image of an infrastructure sensor including an image of the object of attention is to comprehend a cause, a reason, or the like for starting the first business SB1 to the vehicle VH_TRG_SB1 in a short period of time. Therefore, in the sixth example, a final candidate operating a terminal in which a peripheral image of the vehicle VH_TRG_SB1 including an image of the object of attention or an image of an infrastructure sensor including an image of the object of attention is output on a display is selected as the operator OP_SB1.

The operator selecting unit 41 transmits information on the final candidate selected as the operator OP_SB1 to the first business imparting unit 15.

4-2-2. Processing Example is a flow chart showing a flow of processing particularly related to the fourth embodiment by the management server MS (processor 40). The routine shown in FIG. 13 is repetitively executed in, for example, predetermined control cycles.

A basic flow of the routine shown in FIG. 13 is the same as the routine described with reference to FIG. 6. The difference between the routines is that processing to be performed when a determination result of step S13 is positive has been added. In other words, in the routine shown in FIG. 13, processing of steps S41 and S42 is performed when the determination result of step S13 is positive.

In the processing of step S41, a determination is made as to whether or not the total number of operators (in other words, operators OP_SB2) in charge of the second business SB2 to the vehicle VH_TRG_SB1 is two or more. When the determination result of step S41 is negative or, in other words, when the total number of operators in charge of the second business SB2 to the vehicle VH_TRG_SB1 is one, processing of step S16 is performed.

When the determination result of step S41 is positive, processing of step S42 is performed. In the processing of step S42, the operators (in other words, operators OP_SB2) in charge of the second business SB2 to the vehicle VH_TRG_SB1 are considered final candidates of the operator OP_SB1 and one operator is selected from the final candidates. As already described, a selection method is not particularly limited. When narrowing down final candidates using selection criteria, desirably, the first to sixth examples described above are suitably combined. The single selected operator OP_SB2 is assigned the first business SB1 to the vehicle VH_TRG_SB1.

### 4-3. Effects

According to the fourth embodiment described above, the first business SB1 to the vehicle VH_TRG_SB1 can be reliably assigned to a single operator when the total number of operators OPn engaged in the second business SB2 to the vehicle VH_TRG_SB1 is two or more.

### 5. Fifth Embodiment

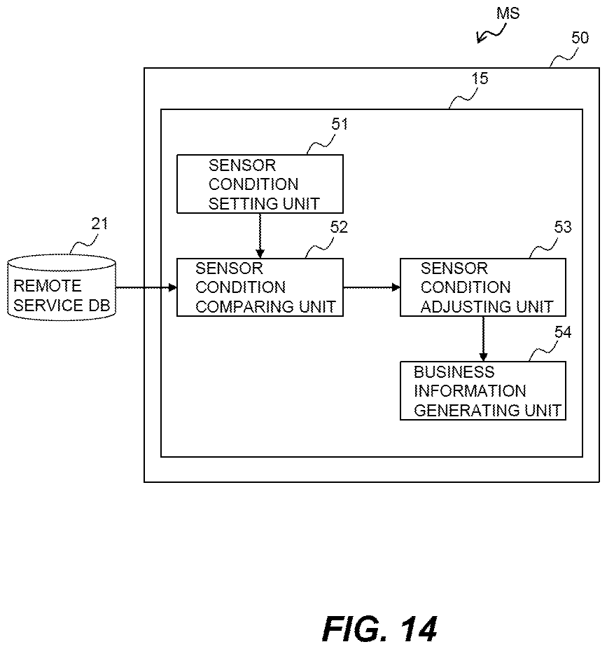

Finally, a fifth embodiment of the present disclosure will be described with reference to FIG. 14. Descriptions overlapping with the descriptions of the first to fourth embodiments will be omitted when appropriate.

### 5-1. Features of Fifth Embodiment

In the first and second embodiments, when there is an operator OPn already engaged in the second business SB2 to the vehicle VH_TRG_SB1, processing for assigning the first business SB1 to the vehicle VH_TRG_SB1 to the operator OPn is performed. Therefore, when the processing is performed, the second business SB2 to the vehicle VH_TRG_SB1 by the operator OPn is brought to a close and, instead, the first business SB1 to the vehicle VH_TRG_SB1 is started.

With a transition among a series of service businesses SB, images output from a display DPn are switched from one to the next. An issue in this case is that an image output from the display DPn in the second business SB2 to an object (in other words, the vehicle VH_SB) in the series of service businesses SB is expected to differ from an image output from the display DPn in the first business SB1 to the vehicle VH_SB.

In consideration thereof, in the fifth embodiment, during a transition among a series of service businesses SB, sensor conditions before and after switching images output from a display DPn are compared with each other. In addition, an image output from the display DPn upon start of the first business SB1 is adjusted based on a difference between the sensor conditions. Performing such processing enables transitions among a series of service businesses SB to be realized in a smooth manner.

### 5-2. Management Apparatus of Remote Service

FIG. 14 is a block diagram showing a configuration example of the management server MS particularly related to the fifth embodiment. In the example shown in FIG. 14, the management server MS includes a processor 50 and the remote service DB 21. The processor 50 includes the first business imparting unit 15 shown in FIG. 5. In the example shown in FIG. 14, the first business imparting unit 15 includes a sensor condition setting unit 51, a sensor condition comparing unit 52, a sensor condition adjusting unit 53, and a business information generating unit 54. The functional units correspond to a configuration example particularly related to the fifth embodiment.

When the operator OP_SB1 is selected by the first business assigning unit 14 (refer to FIG. 5), the sensor condition setting unit 51 sets a sensor condition necessary for executing the first business SB1 to the vehicle VH_TRG_SB1. Examples of the sensor condition include the number of sensors, an orientation of the sensors (an azimuth with an angle of view which combines an azimuth such as front, back, left, right, or the like with an angle of view such as 360 degrees, a wide angle, a narrow angle, or the like), a type of the sensors (a camera, LiDAR, or the like), and a parameter of the sensors (a camera parameter such as brightness, contrast, or aperture, a frame rate, or the like).

The sensor condition is set based on, for example, information on a task in the first business SB1 to the vehicle VH_TRG_SB1 and/or information on an object of attention in the first business SB1. For example, when a determination of a propriety of a start by the vehicle VH_TRG_SB1 is a task in the first business SB1, a sensor condition to output an image of the front (for example, an image of center front, left front, and right front) of the vehicle VH_TRG_SB1 is set. In another example, when a determination of a propriety of a right turn at an intersection by the vehicle VH_TRG_SB1 is a task in the first business SB1, a sensor condition to output an image of the right (for example, an image of right side and right rear) in addition to an image of the front of the vehicle VH_TRG_SB1 is set.

When a determination of a propriety of a left turn at an intersection by the vehicle VH_TRG_SB1 is a task in the first business SB1 and, at the same time, a motorcycle approaching the vehicle VH_TRG_SB1 from left rear of the vehicle VH_TRG_SB1 is an object of attention, a sensor condition to output an image of the front (for example, an image of center front and left front) of the vehicle VH_TRG_SB1 is set. In a case where the vehicle is a ride-sharing vehicle such as a bus, when a determination of a propriety of a start after boarding and alighting of users of a ride-sharing service and safety confirmation of the users at a doorway are tasks in the first business SB1, a sensor condition to output an image of the front (for example, an image of center front, left front, and right front) of the vehicle VH_TRG_SB1 and an image of an interior of the vehicle VH_TRG_SB1 is set.

Let us consider a case where, due to a reason such as communication bands having an upper limit or the like, there is a constraint on the total number of images that can be output from the display DPn. In this case, a sensor condition may be set in advance. For example, let us consider a case where the vehicle is a ride-sharing vehicle and the two tasks described above (determination of propriety of start and safety confirmation at doorway) are tasks in the first business SB1. In this case, outputting an image of the front (for example, an image of center front) of the vehicle VH_TRG_SB1 and an image of the interior of the vehicle VH_TRG_SB1 is expected as the sensor condition set in advance.

Even when there is a constraint to the total number of images that can be output from the display DPn, when information on the tasks and/or the object of attention described above is input to the sensor condition setting unit 51, the sensor condition set in advance may be changed. For example, let us consider a case where the vehicle described above is a ride-sharing vehicle and a user about to miss the ride-sharing vehicle attempts to open a doorway to the side of the vehicle body. In this case, with an output of a start trigger TRG_SB1 which considers the user an object of attention, the sensor condition set in advance may be changed to a sensor condition of outputting an image to the front (for example, an image of center front) of the vehicle VH_TRG_SB1 and an image to the side of the vehicle VH_TRG_SB1.

Note that not all requests to change a sensor condition set in advance can be accepted. Therefore, when there is a request for change, to what degree the request for change is to be accepted is desirably determined according to a certain criterion. As the criterion for determination, the following criteria are exemplified.
Criterion 1: Preferentially accept sensor image in which image of the object of attention has been recognized
Criterion 2: Accept sensor image common with sensor condition set in advance
Criterion 3: Accept sensor condition of which a change is requested over sensor condition set in advance
Criterion 4: Accept sensor condition set in advance over sensor condition of which a change is requested

The sensor condition comparing unit 52 compares the sensor condition set by the sensor condition setting unit 51 with the present sensor condition. The present sensor condition is a sensor condition in the second business SB2 to the vehicle VH_TRG_SB1 and includes the number of sensors, an orientation of the sensors, a type of the sensors, and a parameter of the sensors described above. In the fifth embodiment, information on the present sensor condition is stored in the remote service DB 21.

For example, the sensor condition comparing unit 52 refers to unique information of the operator OP_SB1 selected by the first business assigning unit 14 and extracts information on the present sensor condition from the remote service DB 21. In addition, the sensor condition comparing unit 52 transmits information on a difference between the extracted present sensor condition and the sensor condition set by the sensor condition setting unit 51 to the sensor condition adjusting unit 53.

Based on the information on the difference received from the sensor condition comparing unit 52, the sensor condition adjusting unit 53 sets a sensor condition for engaging in the first business SB1 to the vehicle VH_TRG_SB1. For example, let us consider a case where the second business SB2 to the vehicle VH_TRG_SB1 prior to a transition of the service business SB is the second business SB2 solely to the vehicle VH_TRG_SB1. In this case, it is assumed that the sensor condition related to the number of sensors and the orientation of the sensors is the same as the sensor condition set by the sensor condition setting unit 51. Therefore, adjustments are performed with respect to the type of the sensors and the parameter of the sensors.

As another example, let us consider a case where the second business SB2 to the vehicle VH_TRG_SB1 prior to a transition of the service business SB is the second business SB2 to the vehicle VH_TRG_SB1 based on an image of an infrastructure sensor. In this case, the sensor condition including the number of sensors, an orientation of the sensors, a type of the sensors, and a parameter of the sensors is entirely changed. In yet another example, a change is made to a sensor condition of outputting a peripheral image of the vehicle VH_TRG_SB1 from the display DPn while continuing to output an image of an infrastructure sensor.

The business information generating unit 54 generates business information including the sensor condition after adjustment by the sensor condition adjusting unit 53. The business information may include information which enables an operation of apparatuses (for example, the steering wheel, pedals, the gear shift, and turn signals) related to travel of the vehicle VH_TRG_SB1. The business information generating unit 54 transmits the generated business information to the terminal operated by the operator OP_SB1 selected by the first business assigning unit 14.

### 5-3. Effects

According to the fifth embodiment described above, transitions among a series of service businesses SB can be realized in a smooth manner. In addition, since a sensor condition is adjusted based on information on a difference between sensor conditions, a processing load on the management server MS (processor 50) which accompanies a transition among the series of service businesses SB can be reduced.

What is claimed is:

1. A method for managing a remote service for mobile objects, the method comprising the step of assigning, when a start trigger of a service business to an object for which the remote service is provided is output, the service business to at least one operator among a plurality of operators engaged in the remote service, wherein:
the service business includes a first business which affects travel efficiency of the object of the remote service and a second business which does not affect the travel efficiency; and
the step of assigning the service business includes the steps of:
determining, when a start trigger of the first business for the object of the remote service is output, whether or not an operator already engaged in the second business for the object of the remote service is included in the plurality of operators; and
appointing, when it is determined that an operator already engaged in the second business for the object of the remote service is included in the plurality of operators, the operator having been already engaged in the second business for the object of the remote service to be an operator in charge of the first business for the object of the remote service.

2. The method according to claim 1, wherein:
the second business includes a monitoring business of a traffic flow based on an image of an infrastructure sensor; and
the step of determining whether or not an operator already engaged in the second business for the object of the remote service is included in the plurality of operators includes the step of determining whether or not an operator already engaged in the monitoring business of the image of the infrastructure sensor which includes an image of the object of the remote service is included in the plurality of operators.

3. The method according to claim 1, further comprising the steps of:
determining, when an operator having been already engaged in the second business for the object of the remote service is appointed to be an operator in charge of the first business for the object of the remote service, whether or not the second business in which the operator had been engaged immediately preceding an appointment includes the second business for another object of the remote service; and
outputting, when it is determined that the second business for the another object of the remote service is included, a start trigger of the second business for the another object.

4. The method according to claim 1,
Wherein the step of assigning the service business further includes the steps of:
determining, when it is determined that an operator already engaged in the second business for the object of the remote service is included in the plurality of operators, whether or not a total number of operators already engaged in the second business for the object of the remote service is two or more prior to appointing the operator having been already engaged in the second business for the object of the remote service to be an operator in charge of the first business for the object of the remote service; and
selecting, when it is determined that the total number of operators is two or more, an operator to be placed in charge of the first business for the object of the remote service from among the two or more operators having been already engaged in the second business for the object of the remote service.

5. The method according to claim 1, further comprising the step of changing, when an operator having been already engaged in the second business for the object of the remote service is appointed to be an operator in charge of the first business for the object of the remote service, an output condition of information to be output from a display being monitored by the operator to an output condition in order to engage in the first business for the object of the remote service.

6. An apparatus for managing a remote service for mobile objects, comprising a processor configured to manage the remote service,
wherein the processor is configured to execute processing to assign, when a start trigger of a service business to an object for which the remote service is provided is output, the service business to at least one operator among a plurality of operators engaged in the remote service,
wherein the service business includes a first business which affects travel efficiency of the object of the remote service and a second business which does not affect the travel efficiency, and
wherein, in the processing to assign the service business, the processor is configured to execute:
processing to determine, when a start trigger of the first business for the object of the remote service is output, whether or not an operator already engaged in the second business for the object of the remote service is included in the plurality of operators; and
processing to appoint, when it is determined that an operator already engaged in the second business for the object of the remote service is included in the plurality of operators, the operator having been already engaged in the second business for the object of the remote service to be an operator in charge of the first business for the object of the remote service.

7. The apparatus according to claim 6, wherein:
the second business includes a monitoring business of a traffic flow based on an image of an infrastructure sensor; and
in the processing to determine whether or not an operator already engaged in the second business for the object of the remote service is included in the plurality of operators, the processor is configured to execute processing to determine whether or not an operator already engaged in the monitoring business of the image of the infrastructure sensor which includes an image of the object of the remote service is included in the plurality of operators.

8. The apparatus according to claim 6,
wherein the processor is configured to further execute:
processing to determine, when an operator having been already engaged in the second business for the object of the remote service is appointed to be an operator in charge of the first business for the object of the remote service, whether or not the second business in which the operator had been engaged immediately preceding an appointment includes the second business for another object of the remote service; and
processing to output, when it is determined that the second business for the another object of the remote service is included, a start trigger of the second business for the another object.

9. The apparatus according to claim 6,
wherein, in the processing to assign the service business, the processor is configured to further execute:
processing to determine, when it is determined that an operator already engaged in the second business for the object of the remote service is included in the plurality of operators, whether or not the total number of operators already engaged in the second business for the object of the remote service is two or more prior to appointing the operator having been already engaged in the second business for the object of the remote service to be an operator in charge of the first business for the object of the remote service; and
processing to select, when it is determined that a total number of operators is two or more, an operator to be placed in charge of the first business for the object of the remote service from among the two or more operators having been already engaged in the second business for the object of the remote service.

10. The apparatus according to claim 6,
wherein the processor is configured to further execute:
processing to change, when an operator having been already engaged in the second business for the object of the remote service is appointed to be an operator in charge of the first business for the object of the remote service, an output condition of information to be output from a display being monitored by the operator to an output condition in order to engage in the first business for the object of the remote service.
